(19) United States
(12) Patent Application Publication
(10) Pub. No.: US 2014/0241828 A1
(43) Pub. Date: Aug. 28, 2014

(54) BOLT HEAD COVER

(71) Applicant: NP AEROSPACE LIMITED, Coventry (GB)

(72) Inventor: Christopher Davies, Kenilworth (GB)

(21) Appl. No.: 13/780,602

(22) Filed: Feb. 28, 2013

(51) Int. Cl. F16B 41/00

(52) U.S. Cl. CPC F16B 41/002
USPC 411/373

(57) ABSTRACT

A bolt head cover may include a polymeric shroud for fitting over a bolt head, the shroud may include an end part and a skirt depending from the end part and arranged to fit around the bolt head, and a hard tile within the shroud so as to be located between the bolt head and the end part. A bolt assembly may comprise a bolt with the bolt head cover bonded thereto.

### BACKGROUND TO THE INVENTION

This invention relates to a bolt head cover.

The invention is useful in attaching armor to a vehicle. Conventionally, a steel bolt, usually having a threaded shaft and a non-round, e.g. hexagonal, head is used for this purpose.

When a projectile strikes such a bolt, the head can shear off and damage or even penetrate the armor and/or the vehicle. With heavier armor it is possible to arrange different plates in such a manner that there is no direct path from the outer bolts to the vehicle, although the complexity of the armor system is increased. This is not possible with lighter armor.

### SUMMARY OF THE INVENTION

The present invention provides a bolt head cover including a polymeric shroud for fitting over a bolt head, the shroud including an end part and a skirt depending from the end part and arranged to fit around the bolt head, and a hard tile within the shroud so as to be located between the bolt head and the end part.

The shroud may have a circular or hexagonal outer cross-section. The skirt may have a circular or hexagonal inner cross-section. The skirt may have a tile-holding part adjacent the end part and a bolt-head-receiving part adjacent the tile-holding part, the tile-holding part having a greater internal cross-section than the bolt-head-receiving part.

In one example the shroud is injection molded, for example, from a thermoplastic polyurethane material.

The tile may be a ceramic tile.

The invention also provides a bolt assembly comprising:
a bolt having a shaft and a head; and
a bolt head cover bonded to the head and including an outer shroud and an inner layer adjacent the head, the inner layer being harder than the outer shroud.

The inner layer, which may comprise a ceramic tile, may have an area greater than an area of an end face of the head. The shroud may include a re-entrant part surrounding the head.

### BRIEF DESCRIPTION OF THE DRAWINGS

The invention will now be described by way of example only, with respect to the accompanying drawings, in which:

FIG. 1 is a cut-away view of a bolt head cover according to the invention;

FIG. 2 is an elevation of the bolt head cover according to FIG. 1; and

FIG. 3 is a section taken along the line X-X in FIG. 2, additionally showing a bolt.

### DETAILED DESCRIPTION OF PREFERRED EMBODIMENTS:

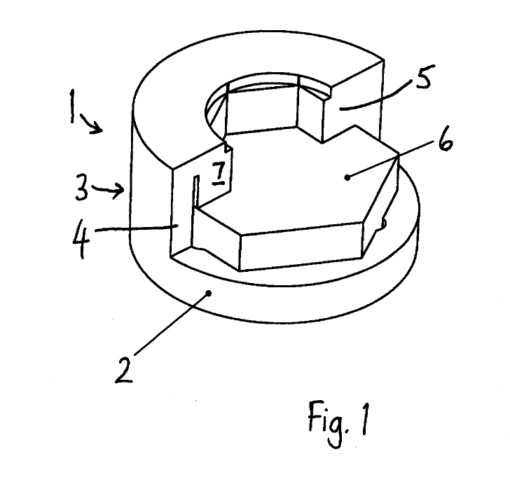

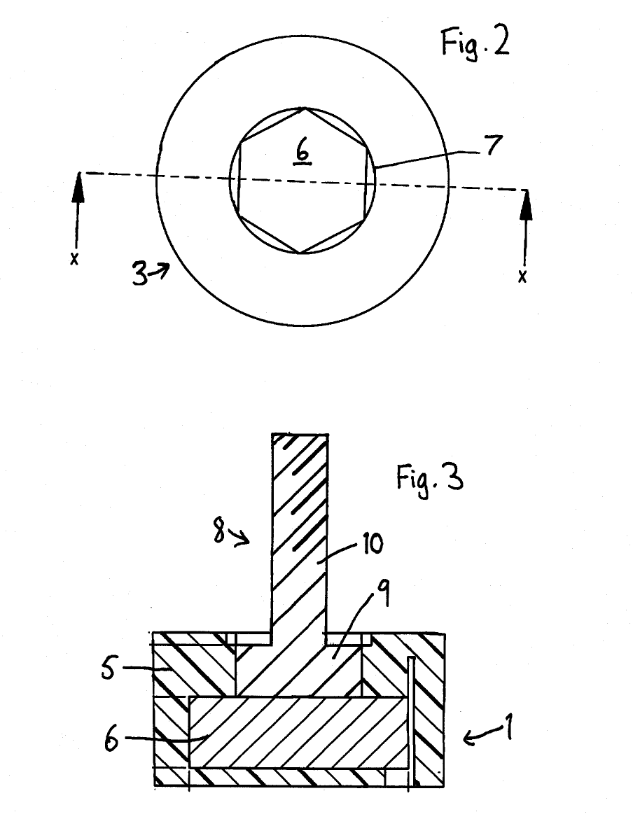

FIGS. 1 to 3 show a bolt head cover comprising a generally cylindrical shroud 1 that has been injection molded in one piece from a thermoplastic polyurethane material such as Desmopan® from Bayer MaterialScience AG of Leverkusen, Germany.

The shroud consists of a disc-shaped end part 2 and a skirt 3 including a tile-holding part 4 and a bolt-head-receiving part 5. A ceramic tile 6, for example of silicon carbide or alumina, is housed in the tile-holding part 4. In this example the tile 6 is hexagonal and is a tight fit within the tile-holding part 4 which has a hexagonal inner cross section. The bolt-head-receiving part 5 also has a hexagonal inner cross section, but with a smaller area than the tile-holding part, and with the sides of the hexagon aligned with those of the tile-holding part 4. Thus a re-entrant part 7 of the bolt-head-receiving part 5 retains the tile 6 within the shroud 1. This may be achieved by molding the shroud around the tile 6.

The bolt head cover can be placed over a bolt 8 having a hexagonal head 9 and a shaft 10, the bolt having been used to attach armor to a vehicle or to assemble layers of armor. The shroud is sized such that the bolt head fits snugly within the bolt-head-receiving part 5, and the head is then bonded to the bolt head cover using a strong adhesive.

The hard tile 6, in combination with the shroud 1, serves to protect the bolt by disrupting a projectile that would otherwise strike the bolt head, potentially removing the head which could then cause catastrophic damage.

The bolt head cover 1 may further include a bolt 8 having a head 9 and a shaft 10, the bolt head 9 being disposed adjacent the hard tile 6 with the bolt head receiving part 5 defined by skirt 3 fitting around the bolt head 9.

A bolt head cover assembly may comprise: a bolt 8 having a head 9 and a shaft 10 extending from the head 9; a tile 6 disposed adjacent the bolt head 9 opposite the shaft 10; an outer shroud 1 bonded to the bolt head 9 and enclosing the tile 6, and the tile 6 may be harder than is the shroud 1. The tile 6 may be a ceramic tile and the outer shroud 1 maybe a thermoplastic polyurethane material. The outer shroud 1 may be injection molded to enclose the tile 1. The outer shroud 1 may define a bolt head receiving part 5 adjacent a tile holding part 4, wherein the bolt head receiving part 5 may be smaller than the tile receiving part 4. The diameter of the tile 6 may be larger than the diameter of the bolt head 9.

Modifications can be made to the specific embodiment described above without departing from the scope of the invention as defined by the claims. In a particular modification, the shroud 1 could have a hexagonal or other non-round outer cross-section instead of the circular shape shown. In this way, the bolt head cover can be attached, preferably with adhesive, to a bolt before the latter is used. Such a bolt assembly can then be tightened by engaging the bolt head cover using a tool such as a spanner, instead of engaging the bolt directly.

In another modification, the tile-holding part could have a round inner cross-section, for use with a bolt having a head of round outer cross-section, such as an Allen bolt. Relative rotation between the bolt head cover and the bolt would be prevented by the adhesive.

1. A bolt head cover including a polymeric shroud for fitting over a bolt head, the shroud including an end part and a skirt depending from the end part and arranged to fit around the bolt head, and a hard tile lodged within the shroud so as to be located between the bolt head and the end part.

2. The bolt head cover according to claim 1, wherein the shroud has a circular or hexagonal outer cross-section.

3. The bolt head cover according to claim 1, wherein the skirt has a circular or hexagonal inner cross-section.

4. The bolt head cover according to claim 1, wherein the skirt has a tile-holding part adjacent the end part and a bolt-head-receiving part adjacent the tile-holding part, the tile-holding part having a greater internal cross-section than the bolt-head-receiving part.

5. The bolt head cover according to claim 1, wherein the shroud is injection molded.

6. The bolt head cover according to claim 1, wherein the shroud is of a thermoplastic polyurethane material.

7. The bolt head cover according to claim 1, wherein the tile is a ceramic tile.

8. The bolt head cover according to claim 1. further including a bolt having a head and a shaft, the bolt head being disposed adjacent the hard tile with the skirt fitting around the bolt head.

9. A bolt head cover assembly comprising:
a bolt having a shaft and a head; and
a bolt head cover bonded to the head and including an outer shroud and an inner layer adjacent the head, the inner layer being harder than the outer shroud.

10. The bolt head cover assembly according to claim 9, wherein the inner layer comprises a ceramic tile.

11. The bolt head cover assembly according to claim 9, wherein the inner layer has an area greater than an area of an end face of the head.

12. The bolt head cover assembly according to claim 9, wherein the shroud includes a re-entrant part surrounding the head.

13. The bolt head cover assembly according to claim 9, wherein the head is bonded to the inner layer.

14. The bolt head cover assembly according to claim 9, wherein the head is bonded to the shroud.

15. A bolt head cover assembly comprising:
a bolt having a head and a shaft extending from the head;
a tile disposed adjacent the bolt head opposite the shaft; and
an outer shroud bonded to the bolt head and enclosing the tile,
wherein the tile is harder than is the shroud.

16. The bolt head cover assembly of claim 15, wherein the tile is a ceramic tile and the outer shroud is a thermoplastic polyurethane material.

17. The bolt head cover assembly of claim 15, wherein the outer shroud is injection molded to enclose the tile.

18. The bolt head cover assembly of claim 15, wherein the outer shroud defines a bolt head receiving part adjacent a tile holding part, wherein the bolt head receiving part is smaller than the tile receiving part.

19. The bolt head cover assembly of claim 15, wherein the diameter of the tile is larger than the diameter of the bolt head.
